(19) United States
(12) Patent Application Publication
(10) Pub. No.: US 2025/0133160 A1
(43) Pub. Date: Apr. 24, 2025

(54) Phone Securing Device

(71) Applicant: Mary Curtis, Charlotte, NC (US)

(72) Inventor: Mary Curtis, Charlotte, NC (US)

(21) Appl. No.: 18/925,884

(22) Filed: Oct. 24, 2024

Related U.S. Application Data
(60) Provisional application No. 63/592,711, filed on Oct. 24, 2023.

(51) Int. Cl. H04M 1/04; A45F 5/02

(52) U.S. Cl. CPC H04M 1/04; A45F 5/02; A45F 5/1516

(57) ABSTRACT

A phone leash device is disclosed for attaching a phone to a clothing item or belonging of a user. The phone leash device comprises a clip component that attaches to the user and an additional phone component that features an adhesive used to attach the device to the phone. Connecting these two components is an expandable cable that functions as a leash. Thus, once the device is adhered to the back surface of a phone and the push clip is attached to the user, the device acts as a leash for a phone that prevents dropping, loss, or theft.

### CROSS-REFERENCE TO RELATED APPLICATION

The present application claims priority to, and the benefit of, U.S. Provisional Application No. 63/592,711, which was filed on Oct. 24, 2023, and is incorporated herein by reference in its entirety.

### FIELD OF THE INVENTION

The present invention relates generally to the field of phone-securing devices. More specifically, the present invention relates to a phone leash device that secures a mobile phone to the user or the user's belongings. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in phone leash devices. Generally, dropping or loss of mobile phones is a widespread concern of those who use them. This concern is particularly relevant while walking over drain grates, elevator gaps, holding a phone over a railing to take pictures, traveling, boating, and an endless number of additional scenarios.

As is known, and particularly in crowded or foreign areas, pickpocketing is also a relevant concern. It is easy to have a mobile phone stolen directly out of a clothing, luggage, or purse pocket in a busy area, without noticing until it is too late.

Accordingly, there is a demand for an improved phone leash device that secures a mobile phone to prevent dropping, loss, or theft of the phone. More particularly, there is a demand for a phone leash device that securely attaches a mobile phone to the body or belongings of the user.

Therefore, there exists a long felt need in the art for a phone leash device that provides users with a secure means of attaching their phone to their body, clothing, luggage, purse, or other belongings. There is also a long felt need in the art for a phone leash device that features a secure adhesive side that can attach directly to the back surface of a phone. Further, there is a long felt need in the art for a phone leash device that features a reversibly expandable cable that acts as a leash attaching the phone to the user. Finally, there is a long felt need in the art for a device that secures easily to the body or belongings of a user via a convenient push clip.

The subject matter disclosed and claimed herein, in one embodiment thereof, comprises a phone leash device. The device is a leash-like device that secures a mobile phone to the body or belongings of a user. The device features a secure adhesive on one side that is used to attach the device directly to the back surface of a phone. The device also features an expandable cable that acts as a leash, attaching the phone that is adhered to the device to the body or belongings of a user. Further, the device comprises a convenient push clip design to reversibly attach to the clothing, luggage, purse, or other belongings of the user. Thus, once the device is adhered to the back surface of a phone and the push clip is attached to the user or their belongings, the device acts as a leash for a phone. Accordingly, the device effectively prevents the dropping, loss, or theft of the phone.

In this manner, the phone leash device of the present invention accomplishes all of the forgoing objectives and provides users with a device that enables for a means of securely attaching a phone to the user.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a phone leash device. The device is a leash device that attaches a phone to the body, clothing, or accessory of a user. The phone leash device comprises a clip component that attaches to the user and an additional phone component that features an adhesive used to attach the device to the phone. Connecting these two components is an expandable cable that functions as a leash. Thus, once the device is adhered to the back surface of a phone and the push clip is attached to the user (i.e., user's clothing), the device acts as a leash for a phone that prevents dropping, loss, or theft.

In one embodiment, the phone leash device of the present invention assists any setting in which dropping, loss, or theft of a phone is a concern. The phone leash device secures easily to a user or their belongings and provides a worry-free phone carrying experience. The phone leash device provides for mobile phone drop, loss, and theft protection. The phone leash device includes an expandable cable that acts as a leash between the user and the phone. The device is portable in that it is configured to be easily carried by a person.

In one embodiment, the phone leash device comprises a phone component and a push clip component. Generally, and when the device is collapsed, the phone component and push clip component are secured together via a button-actuated fastener. While the present embodiment features a button-actuated fastener, an infinite number of additional embodiments may feature different styles of fasteners so long as they are suitable for the purpose described. When the button is pressed, the phone component and push clip component separate and release an expandable cable from within. When the device is fully collapsed and the phone component and push clip component are adjoined, the phone leash device is generally rectangular in shape, although any shape deemed suitable for the purpose described and/or a distributor or user desires can be used.

In one embodiment, the expandable cable is a sturdy braided cable that is easily folded up inside of the phone component and push clip component when not in use.

In one embodiment, the phone component features an adhesive side that is used to adhere the device to the back surface of a phone. Generally, the adhesive is a secure yet residue-free means of joining the phone component of the device to the back of a phone.

In one embodiment, the phone leash device in accordance with the present invention can be produced in various colors, designs, patterns, etc., and feature logos, emblems and or designs, such as a distributor requests and/or a user desires.

In one embodiment, the phone leash device is manufactured of a high-density polyethylene (HDPE), or any other suitable materials as is known in the art. Any number of different types of materials can be used to make the phone leash device including but not limited to plastics, metal, ceramics, etc.

In use, a user adheres the phone component to the back surface of a phone via the adhesive side of the phone component. Next, the user attaches the push clip component of the device to their clothing, luggage, purse, bookbag, backpack, accessory, or other belongings. Further, the user pushes the button on the push clip component to release the expandable cable component. In this manner, the phone leash device prevents dropping, loss, or theft of the phone.

It will also be appreciated that there are a number of additional add-on features that can be incorporated into the device and moreover, the phone leash device can take many different forms as is known in the art.

In yet another embodiment, the phone leash device comprises a plurality of indicia.

In yet another embodiment, a method of conveniently securing a phone to the user is disclosed. The method includes the steps of providing a phone leash device comprising a phone component, push clip component, and an expandable cable. The method also comprises adhering the phone component to the back surface of a phone via the adhesive side of the phone component. Next, the method comprises attaching the push clip component of the device to the clothing, luggage, purse, bookbag, backpack, or other belongings of a user. Further, the method comprises pushing the button on the push clip component to release the expandable cable component. Finally, the method comprises utilizing the device to prevent dropping, loss, or theft of the phone.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the phone leash device of the present invention in the fully collapsed position and attached to the back of a mobile phone in accordance with the disclosed architecture;

FIG. 2 illustrates another perspective view of one embodiment of the phone leash device of the present invention in the fully collapsed position and attached to the back of a mobile phone in accordance with the disclosed architecture;

FIG. 3 illustrates a closer perspective view of one embodiment of the phone leash device of the present invention showing the adhesive side of the phone component of the device in accordance with the disclosed architecture;

FIG. 4 illustrates a perspective view of one embodiment of the phone leash device of the present invention in both the fully collapsed and expanded positions attached to the back of a phone in accordance with the disclosed architecture;

FIG. 5 illustrates a drawing of a perspective view of the expanded and collapsed positions of the phone leash device attached and detached from a phone in accordance with the disclosed architecture;

FIG. 6 illustrates an infographic showing various perspective views of the phone leash device and detailing the purpose, function, and various advantages of the phone leash device in accordance with the disclosed architecture; and

FIG. 7 illustrates a flowchart showing the method of conveniently securing a phone to a user via the phone leash device in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a phone leash device that provides users with a secure means of attaching their phone to their body, luggage, purse, accessory, bookbag, backpack, or other belongings. There is also a long felt need in the art for a phone leash device that features a secure adhesive side that can attach directly to the back surface of a phone. Further, there is a long felt need in the art for a phone leash device that features a reversibly expandable cable that acts as a leash attaching the phone to the user. Finally, there is a long felt need in the art for a device that secures easily to the body or belongings of a user via a convenient push clip.

The present invention, in one exemplary embodiment, is a novel phone leash device for the prevention of dropping, loss, or theft of a phone. The phone leash device comprises a clip component that attaches to the user and a phone component that features an adhesive used to attach the device to the phone. Connecting these two components is an expandable cable that functions as a leash. Thus, once the device is adhered to the back surface of a phone and the push clip is attached to the user, the device acts as a leash for a phone that prevents dropping, loss, or theft.

The present invention also includes a novel method of conveniently securing a phone to a user. The method includes the steps of providing a phone leash device comprising a phone component, push clip component, and an expandable cable. The method also comprises adhering the phone component to the back surface of a phone via the adhesive side of the phone component. Next, the method comprises attaching the push clip component of the device to the clothing, luggage, purse, accessory, bookbag, backpack, or other belongings of a user. Further, the method comprises pushing the button on the push clip component to release the expandable cable component. Finally, the method comprises utilizing the device to prevent dropping, loss, or theft of the phone.

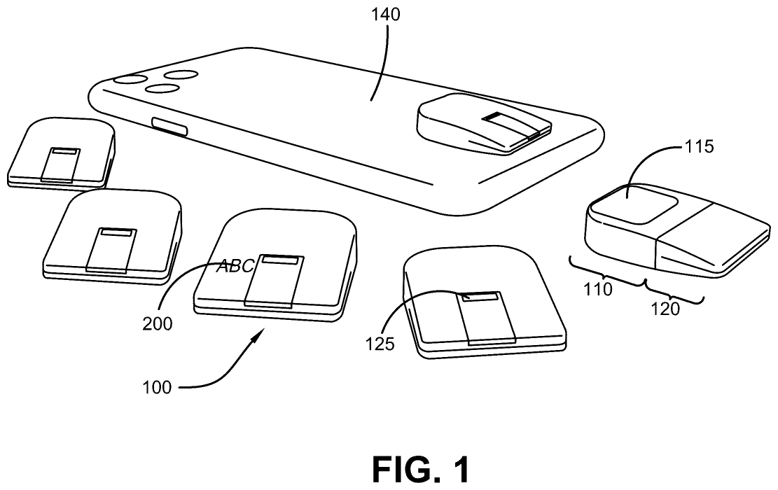

Referring initially to the drawings, FIG. 1 illustrates a perspective view of one embodiment of the phone leash device 100 of the present invention in the fully collapsed position and attached to the back of a mobile phone 140. In the present embodiment, the phone leash device 100 is an improved phone leash device 100 that provides a user with a convenient means of attaching their phone 140 to their person or belongings Specifically, the phone leash device 100 comprises a phone component 110 and a push clip component 120. The phone component 110 is attached to the back surface of a phone 140 and the push clip component is attached to the clothing or other belongings of a user. Thus, once the phone component 110 of the device 100 is connected to the phone 140 and the push clip component 120 is attached to the user, the phone 140 is secured to the user.

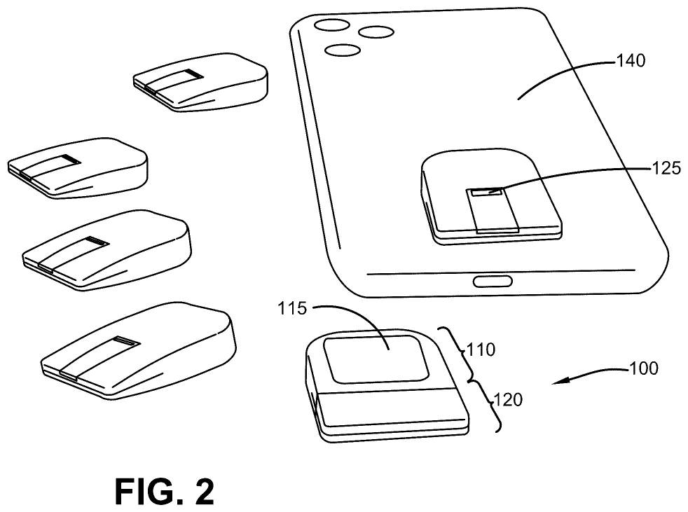

As shown in FIG. 2, the phone component 110 features an adhesive side 115. The adhesive side 115 is used to adhere the phone component 110 of the device 100 to the back surface of a phone 140. Also shown in FIG. 2 is the release button 125 of the push clip component 120. The release button 125 can be pressed to expand the device 100, separating the phone component 110 and the push clip component 120.

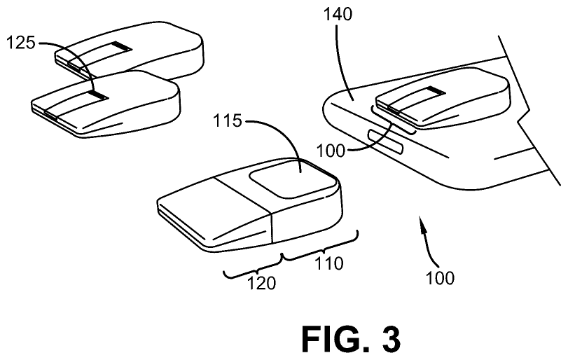

FIG. 3 illustrates a closer perspective view of one embodiment of the phone leash device 100 of the present invention showing the adhesive side 115 of the phone component 110 of the device 100. The adhesive side 115 attaches to the back surface of a phone 140 and is generally comprised of a secure but residue-free adhesive, although any adhering means deemed suitable for the purpose described may be used.

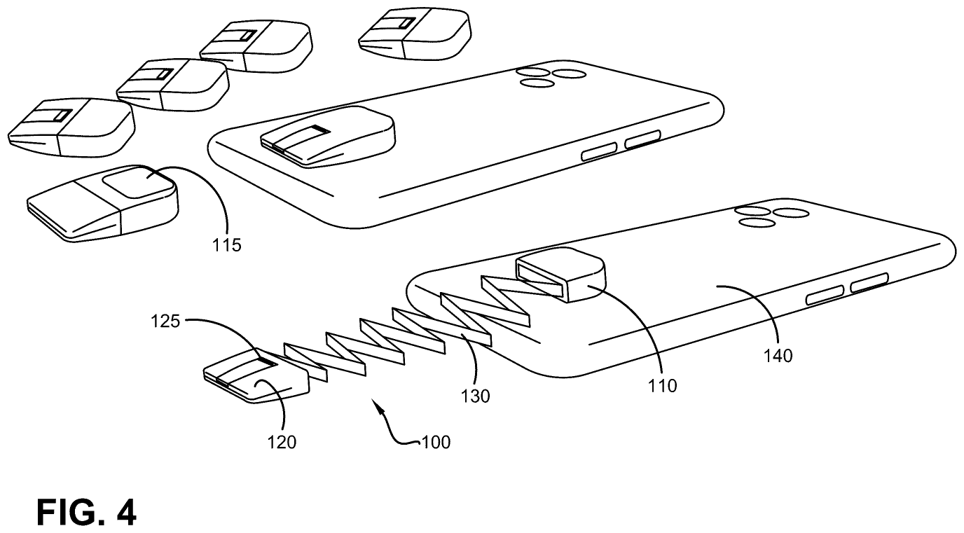

As shown in FIG. 4, the device 100 is expandable via actuation of the release button 125 located on the push clip component 120 of the device 100. After actuation of the release button 125, the phone component 110 and push clip component 120 separate and release an expandable cable 130. The expandable and retractable 130 is generally a strong braided cable that is easily foldable within the interior cavities of the phone component 110 and the push clip component 120.

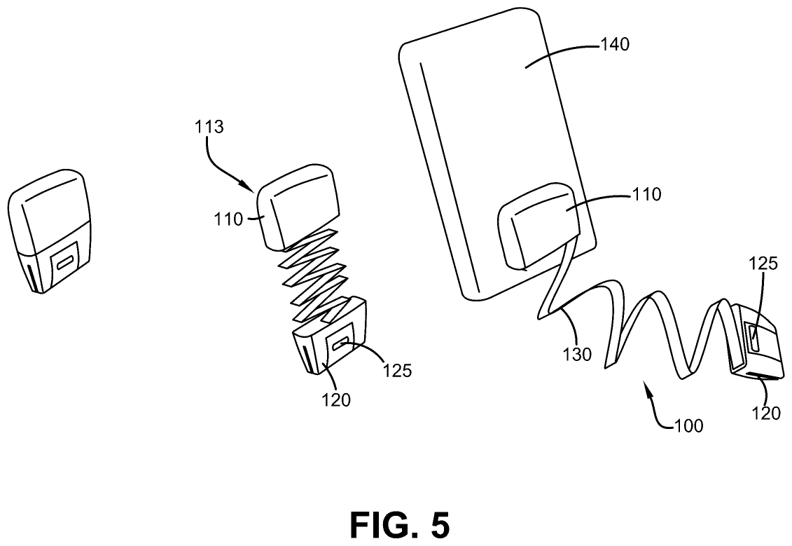

FIG. 5 illustrates a drawing of a perspective view of the expanded and collapsed positions of the phone leash device 100 attached and detached from a phone 140. The phone leash device 100 is capable of preventing the dropping, loss, or theft of a phone 140 in either the expanded or collapsed positions. The user can utilize their phone 140 as the device 100 continues to secure the phone 140 to the user in the expanded position.

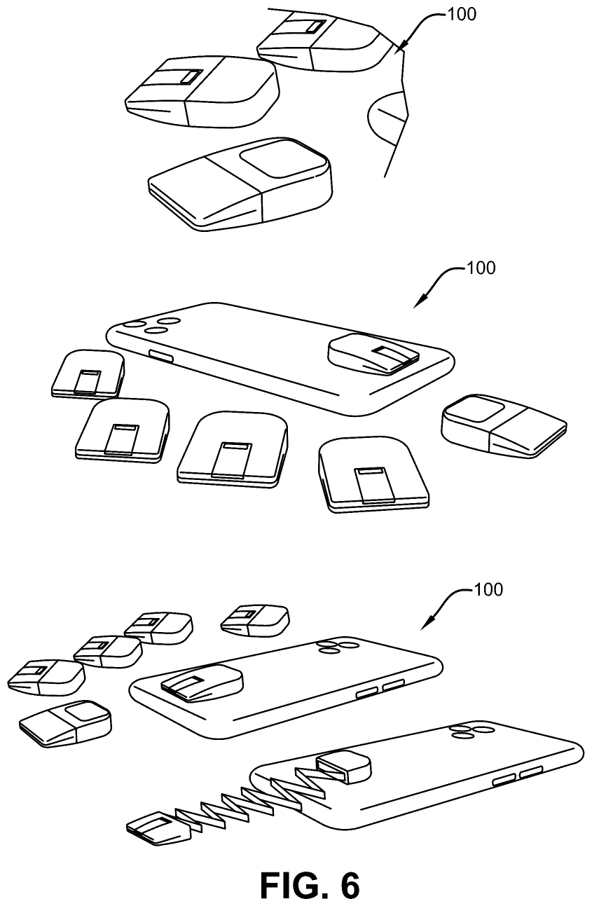

FIG. 6 is an infographic showing various perspective views of the phone leash device 100 and detailing the purpose, function, and various advantages of the phone leash device 100. The phone leash device 100 is useful in any setting in which dropping, theft, or loss of a phone 140 is a concern. These protective qualities of the phone leash device 100 are particularly useful in scenarios where the damage or loss of a phone would be likely and/or devastating, including but not limited to crowded areas or during travel.

In one embodiment, the phone leash device 100 is manufactured of a high-density polyethylene (HDPE), or any other suitable materials as is known in the art. Any number of different types of materials can be used to make the phone leash device 100 including but not limited to heat-scalable plastic or polymers, such as polypropylene or acrylonitrile-butadiene-styrene (ABS), or any other suitable material as is known in the art, such as but not limited to, acrylic, polycarbonate, polyethylene, polyethylene terephthalate, polyvinyl chloride, polystyrene, etc.

In yet another embodiment, the phone leash device 100 comprises a plurality of indicia 200. The phone component 110 or the push clip component 120 of the device 100 may include advertising, a trademark, or other letters, designs, or characters, printed, painted, stamped, or integrated into the phone component 110 or the push clip component 120 or any other indicia 200 as is known in the art. Specifically, any suitable indicia 200 as is known in the art can be included, such as but not limited to, patterns, logos, emblems, images, symbols, designs, letters, words, characters, animals, advertisements, brands, etc., that may or may not be phone related.

It will also be appreciated that there are a number of additional add-on features that can be incorporated into the device 100 and moreover, the phone leash device 100 can take many different forms as is known in the art.

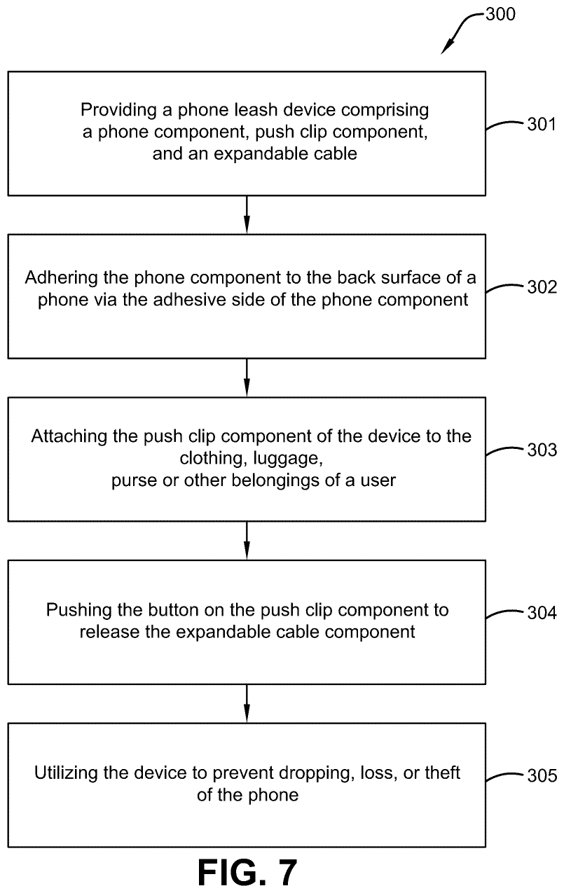

FIG. 7 illustrates a flowchart of the method 300 of conveniently securing a phone to the user. The method includes the steps of at 301, providing a phone leash device comprising a phone component, push clip component, and an expandable cable. The method also comprises at 302, adhering the phone component to the back surface of a phone via the adhesive side of the phone component. Next, the method comprises at 303, attaching the push clip component of the device to the clothing, accessory, bookbag, backpack, luggage, purse, or other belongings of a user. Further, the method comprises at 304, pushing the button on the push clip component to release the expandable cable component. Finally, the method comprises at 305, utilizing the device to prevent dropping, loss, or theft of the phone.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “phone leash device”, “leash device”, “phone leash”, and “device” are interchangeable and refer to the phone leash device 100 of the present invention.

Notwithstanding the forgoing, the phone leash device 100 of the present invention can be of any suitable size and configuration as is known in the art without affecting the overall concept of the invention, provided that it accomplishes the above stated objectives. One of ordinary skill in the art will appreciate that the phone leash device 100 as shown in FIGS. 1-6 is for illustrative purposes only, and that many other sizes and shapes of the phone leash device 100 are well within the scope of the present disclosure. Although the dimensions of the phone leash device 100 are important design parameters for user convenience, the phone leash device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A phone leash device for securing a phone with a user comprising:
a phone leash;
a phone attachment component; and
a push clip component;
wherein said phone leash expandable and retractable;
wherein said phone attachment component attachable to a back surface of a phone;
wherein said push clip component attachable to a belonging of a user; and
further wherein said belonging is selected from the group consisting of a clothing, a luggage, a purse, an accessory, a bookbag, and a backpack.

2. The phone leash device for securing a phone with a user of claim 1, wherein said phone attachment component having an adhesive side for adhering to the back surface of the phone.

3. The phone leash device for securing a phone with a user of claim 2, wherein said push clip component having a release button for releasing said phone leash from said push clip component.

4. The phone leash device for securing a phone with a user of claim 3, wherein said release button when actuated separates said phone attachment component from said push clip component.

5. The phone leash device for securing a phone with a user of claim 4, wherein said phone leash device expandable into two components comprising said phone attachment component and said push clip component.

6. The phone leash device for securing a phone with a user of claim 5, wherein said phone attachment component and said push clip component selectively separable upon actuation of said release button.

7. The phone leash device for securing a phone with a user of claim 6, wherein said phone leash comprising an expandable and retractable cable.

8. The phone leash device for securing a phone with a user of claim 7, wherein said cable is a braided cable.

9. The phone leash device for securing a phone with a user of claim 8, wherein said leash having a material selected from the group consisting of a heat-sealable polymer, a polypropylene, and an acrylonitrile-butadiene-styrene.

10. The phone leash device for securing a phone with a user of claim 8, wherein said leash having a material selected from the group consisting of an HDPE, an acrylic, a polycarbonate, a polyethylene, a polyethylene terephthalate, a polyvinyl chloride, and a polystyrene.

11. A phone leash device for securing a phone with a user comprising:
a phone leash;
a phone attachment component; and
a push clip component;
wherein said phone leash expandable and retractable;
wherein said phone attachment component attachable to a back surface of a phone;
wherein said push clip component attachable to a belonging of a user;
wherein said phone attachment component having an adhesive side for adhering to the back surface of the phone;
wherein said push clip component having a release button for releasing said phone leash from said push clip component; and
further wherein said release button when actuated separates said phone attachment component from said push clip component.

12. The phone leash device for securing a phone with a user of claim 11, wherein said belonging is selected from the group consisting of a clothing, a luggage, a purse, an accessory, a bookbag, and a backpack.

13. The phone leash device for securing a phone with a user of claim 12, wherein said phone leash device expandable into two components comprising said phone attachment component and said push clip component.

14. The phone leash device for securing a phone with a user of claim 13, wherein said phone attachment component and said push clip component selectively separable upon actuation of said release button.

15. The phone leash device for securing a phone with a user of claim 14, wherein said phone leash comprising an expandable and retractable cable.

16. The phone leash device for securing a phone with a user of claim 15, wherein said cable is a braided cable.

17. The phone leash device for securing a phone with a user of claim 16, wherein said leash having a material selected from the group consisting of a heat-sealable polymer, a polypropylene, and an acrylonitrile-butadiene-styrene.

18. The phone leash device for securing a phone with a user of claim 17, wherein said leash having a material selected from the group consisting of an HDPE, an acrylic, a polycarbonate, a polyethylene, a polyethylene terephthalate, a polyvinyl chloride, and a polystyrene.

19. A method of securing and using a phone with a user, the method comprising the steps of:
providing a phone leash, a phone attachment component, and a push clip component, wherein said phone leash expandable and retractable, further wherein said push clip component having a release button for releasing said phone leash from said push clip component;
attaching said phone attachment component to a back surface of a phone, wherein said phone attachment component having an adhesive side for adhering to the back surface of the phone;
attaching said push clip component to a belonging of a user, wherein said belonging is selected from the group consisting of a clothing, a luggage, a purse, an accessory, a bookbag, and a backpack;
actuating said release button separates said phone attachment component from said push clip component; and
expanding said phone leash device into three components comprising said phone attachment component, said push clip component, and said phone leash, wherein said phone attachment component and said push clip component selectively separable upon actuation of said release button for use of the phone by the user.

20. The method of securing and using a phone with a user of claim 19, wherein said phone leash comprising an expandable and retractable cable, wherein said cable is a braided cable, and further wherein said leash having a material selected from the group consisting of a heat-sealable polymer, a polypropylene, and an acrylonitrile-butadiene-styrene.
